(19) United States
(12) Patent Application Publication
(10) Pub. No.: US 2026/0059518 A1
(43) Pub. Date: Feb. 26, 2026

(54) METHOD AND APPARATUS FOR PDU SET BASED SCHEDULING

(71) Applicant: Apple Inc., Cupertino, CA (US)

(72) Inventors: Fangli Xu, Beijing (CN); Ralf Rossbach, Munich (DE); Ping-Heng Kuo, London (GB); Haijing Hu, Los Gatos, CA (US)

(73) Assignee: Apple Inc., Cupertino, CA (US)

(21) Appl. No.: 19/102,336

(22) PCT Filed: Aug. 8, 2022
(86) PCT No.: PCT/CN2022/110904

§ 371 Date: Feb. 7, 2025

(51) Int. Cl. H04W 72/12; H04L 1/1812; H04W 72/231; H04W 72/543

(52) U.S. Cl. CPC H04W 72/12; H04L 1/1812; H04W 72/231; H04W 72/543

(57) ABSTRACT

A method for a user equipment (UE), comprising: acquiring scheduling information in a scheduling occasion for at least one protocol data unit (PDU) in a PDU set, wherein the scheduling information is used for determining a plurality of occasions, each of the plurality of occasions corresponds to data transmission or reception of one or more PDU in the PDU set; and performing data transmission or reception for each PDU in the PDU set via a corresponding occasion of the plurality of occasions determined by the scheduling information.

### TECHNICAL FIELD

The present disclosure relates to the field of wireless communication, and more specifically, to a method and an apparatus for protocol data unit (PDU) set based scheduling.

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE); fifth-generation (5G) 3GPP new radio (NR) standard; the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, new radio (NR) node or g Node B (gNB), which communicate with a wireless communication device, also known as user equipment (UE).

### SUMMARY

According to some embodiments of the present disclosure, a method for a user equipment (UE) is provided. The method comprises: acquiring scheduling information in a scheduling occasion for at least one protocol data unit (PDU) in a PDU set, wherein the scheduling information is used for determining a plurality of occasions, each of the plurality of occasions corresponds to data transmission or reception of one or more PDU in the PDU set; and performing data transmission or reception for each PDU in the PDU set via a corresponding occasion of the plurality of occasions determined by the scheduling information.

According to some embodiments of the present disclosure, a method for a network device in communication with a user equipment (UE) is provided. The method comprises: transmitting, to the UE, scheduling information in a scheduling occasion for at least one Protocol Data Unit (PDU) in a PDU set, wherein the scheduling information is used for determining a plurality of occasions, each of the plurality of occasions corresponds to data transmission or reception of one or more PDU in the PDU set.

According to some embodiments of the present disclosure, an apparatus for a communication device is provided that comprises means for performing the steps of the method as described above.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a UE in accordance with some embodiments.

FIG. 2 is a flow chart illustrating a method for a UE in accordance with some embodiments.

FIGS. 3a-3b illustrate schematic diagrams for an exemplary method for a UE in accordance with some embodiments.

FIGS. 4a-4b illustrate schematic diagrams for an exemplary method for a UE in accordance with some embodiments.

FIGS. 5a-5b illustrate schematic diagrams for an exemplary method for a UE in accordance with some embodiments.

FIGS. 6a-6b illustrate schematic diagrams for an exemplary method for a UE in accordance with some embodiments.

FIG. 7 illustrates a communication device (e.g., a UE or a base station) in accordance with some embodiments.

FIG. 8 illustrates example interfaces of baseband circuitry in accordance with some embodiments.

FIG. 9 illustrates components in accordance with some embodiments.

FIG. 10 illustrates an architecture of a wireless network in accordance with some embodiments.

### DETAILED DESCRIPTION

In the present disclosure, a “network device” or “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE).

As used herein, the terms “user equipment”, “network device” and “base station” are not specific to or otherwise limited to any particular Radio Access Technology (RAT), unless otherwise noted. In general, such UEs may be any wireless communication device (e.g., a mobile phone, router, tablet computer, laptop computer, tracking device, Internet of Things (IoT) device, etc.) used by a user. A UE may be mobile or may (e.g., at certain times) be stationary, and may communicate with a Radio Access Network (RAN).

As used herein, the term “and/or” or “at least one of” includes any and all combinations of one or more of the associated listed items.

In 5G network, the quality of service (QoS) flow is the finest granularity of QoS differentiation in the PDU session. Each packet in the QoS flow is treated according to the same QoS requirement. The QoS handling (e.g., QoS parameters maintenance and QoS scheduling in medium access control (MAC)) is applied per packet or per PDU.

Data traffic in a group of packets are applied in the extended reality (XR) or media service. The group of packets are used to carry payloads of a PDU set (e.g., a frame, video slice, or tile). A PDU set based scheduling is required to improve the performance for such a data traffic.

Aim to this, it is provided by the present disclosure a method and an apparatus for PDU set based scheduling. Principles and implementations of the present disclosure will be described in detail below with reference to the drawings.

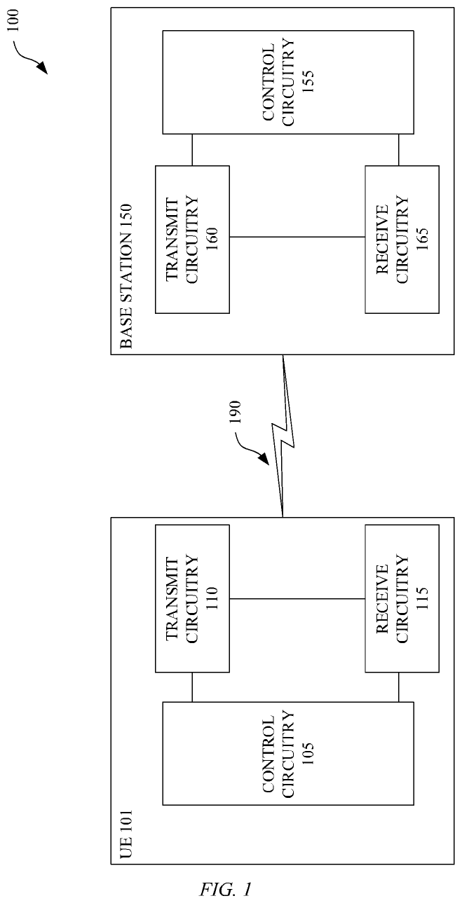

FIG. 1 is a block diagram of a system including a base station and a user equipment (UE) in accordance with some embodiments. FIG. 1 illustrates a wireless network 100, in accordance with some embodiments. The wireless network 100 includes a UE 101 and a base station 150 connected via an air interface 190.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120 degree area with an array of antennas directed to each sector to provide 360 degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with MTC. In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuity 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g. messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person to person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is comprised of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is comprised of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

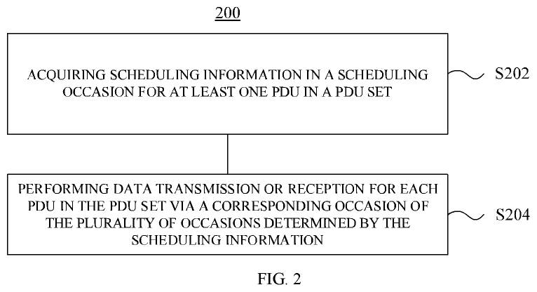

FIG. 2 is a flow chart illustrating a method 200 for a UE in accordance with some embodiments. For the purpose of discussion, the method 200 will be described with reference to FIG. 1. For example, the UE may be the UE 101 shown in FIG. 1. The UE may acquire the scheduling information for at least one PDU in a PDU set from the network device, e.g., from the base station 150. It is to be understood that the method 200 may include additional blocks not shown and/or may omit some shown blocks, and the scope of the present disclosure is not limited in this regard.

As shown in FIG. 2, the method 200 for a UE comprises the following steps: S202, acquiring scheduling information in a scheduling occasion for at least one PDU in a PDU set, wherein the scheduling information is used for determining a plurality of occasions, each of the plurality of occasions corresponds to data transmission or reception of one or more PDU in the PDU set; and S204, performing data transmission or reception for each PDU in the PDU set via a corresponding occasion of the plurality of occasions determined by the scheduling information.

The scheduling information may be acquired via downlink control information (DCI). A bundle of UL grants or DL assignments may be allocated in the scheduling information for the transmission or reception of a whole PDU set or at least part of the PDU set (e.g., some PDU in the PDU set).

In some embodiments, the data transmission or reception is not performed in a repetition manner. In this case, within the bundle of UL grants or DL assignments, the MAC PDU transmitted or received via different UL grants or DL assignments is different. In other words, each PDU in the PDU set can be transmitted or received via only one UL grant or DL assignment, respectively.

A plurality of occasions (e.g., the UL grant occasions or DL assignment occasions) can be determined based on the bundle of UL grants or DL assignments allocated in the scheduling information, which means that the UE can deliver the UL transmission or monitor to receive DL at the plurality of occasions determined by the bundle of UL grants or DL assignments, respectively. In some embodiments, one PDU is transmitted or received via one corresponding occasion. In some other embodiments, more than one PDU is transmitted or received via one corresponding occasions.

In some embodiments, the plurality of occasions are determined by the scheduling information based on Quality of Service (QoS) requirements of the PDU set. For the cases that the scheduling information is acquired by the UE from a network device, the scheduling information can be generated by the network device based on the QoS requirements of the PDU set.

Further, in some embodiments, the QoS requirements include a start time of the PDU set and an end time of the PDU set, and the plurality of occasions are between the start time of the PDU set and the end time of the PDU set. For example, in some application scenarios in the XR field, the data of the PDU set may be considered as effective only for a given period of time. Therefore, determining the scheduling information based on the start time and end time may ensure that the transmission or reception of the data of the PDU set can be performed within the given period of time.

In some embodiments, the scheduling information acquired by the UE in a single scheduling occasion can be used for scheduling the whole PDU set. In some other embodiments, since the related data is not arrived at the same time or the current radio capacity does not allow such a scheduling information, the network device cannot provide the scheduling information to accommodate the data of the whole PDU set. In such a case, the network devices can provide the scheduling information for a part of the PDU set in the scheduling occasion. The UE, after acquiring the scheduling information, can perform the data transmission or reception for the part of the PDU set.

In some embodiments, the scheduling information may indicate the number of the occasions and the interval between two occasions. Based on that, a plurality of occasions may be determined and the UE can perform the data transmission or reception via such occasions. In some embodiments, the scheduling information is acquired via one of downlink control information (DCI), L2 signaling, or a radio resource control (RRC) message, and the scheduling information indicates a number of the plurality of occasions and an interval between the plurality of occasions. Block S204 the performing the data transmission or reception comprises: performing the data transmission or reception via the number of the plurality of occasions with the interval, wherein each PDU is transmitted or received via a corresponding occasion of the plurality of occasions.

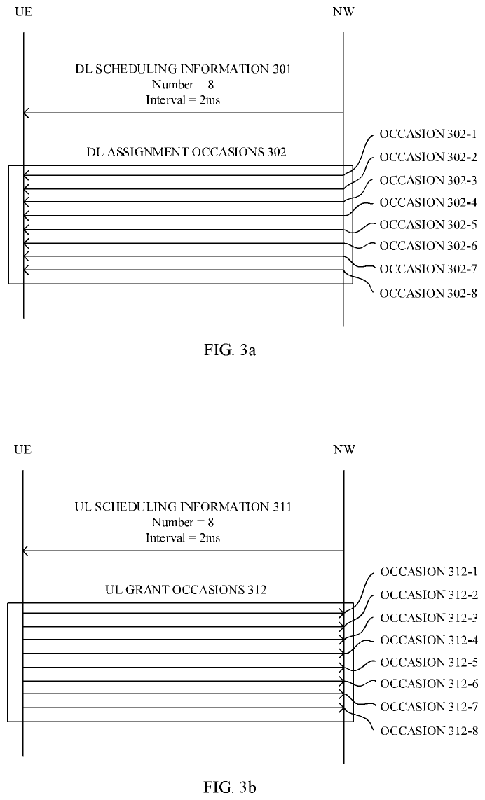

FIGS. 3a-3b illustrate schematic diagrams for an exemplary method for a UE in accordance with some embodiments.

As shown in FIG. 3a, the UE acquires, from the network side (NW), the DL scheduling information 301 for a PDU set with the number of occasions (Num=8) and the interval (Interval=2 ms). Therefore, the DL assignment occasions 302 is determined including 8 occasions (occasion 302-1 to 302-8) for the DL data reception. The interval between the occasions (e.g., between occasion 302-1 and occasion 302-2) is set to be 2 ms. The first occasion 302-1 may be determined according to the scheduling information, e.g., determined by the start time of the PDU set. After the first occasion 302-1, the following 7 occasions are determined with the given interval 2 ms. In some embodiments, in response to detecting the end of the last occasion 302-8, the DL assignment occasions 302 are released.

Similarly, regarding the UL transmission, the scheduling information may include the number of occasions and the interval as well. As shown in FIG. 3b, the UE acquires, from the NW, the UL scheduling information 311 for a PDU set with the number of occasions (Num=8) and the interval (Interval=2 ms). The UL grant occasions 312 include 8 occasions (occasion 312-1 to 312-8) with the given interval 2 ms for data transmission, where the first occasion 312-1 may be determined according to the start time of the PDU set. In some embodiments, in response to detecting the end of the last occasion 312-8, the UL grant occasions 312 are released.

In some embodiments, the DL scheduling information 301 and the UL scheduling information 311 may be acquired by the UE via DCI, RRC, or via other L2 signaling.

Further, it is to be understood that other numbers of PDU or other values of interval may also be indicated by the DL scheduling information 301 and the UL scheduling information 311, and the occasions included in the DL assignment occasions 302 and UL grant occasions 312 may be adjusted based on the scheduling information, respectively.

In some embodiments, the scheduling information may indicate a validity duration of multiple occasions and an interval between each two occasions. The UE may follow the interval to receive the data within the validity duration. In some embodiments, the scheduling information is acquired via downlink control information (DCI), and the scheduling information indicates a duration for the data transmission or reception of the PDU set and an interval between the plurality of occasions. The performing the data transmission or reception comprises: performing the data transmission or reception via the plurality of occasions in the duration with the interval, wherein each PDU is transmitted or received via a corresponding occasion of the plurality of occasions.

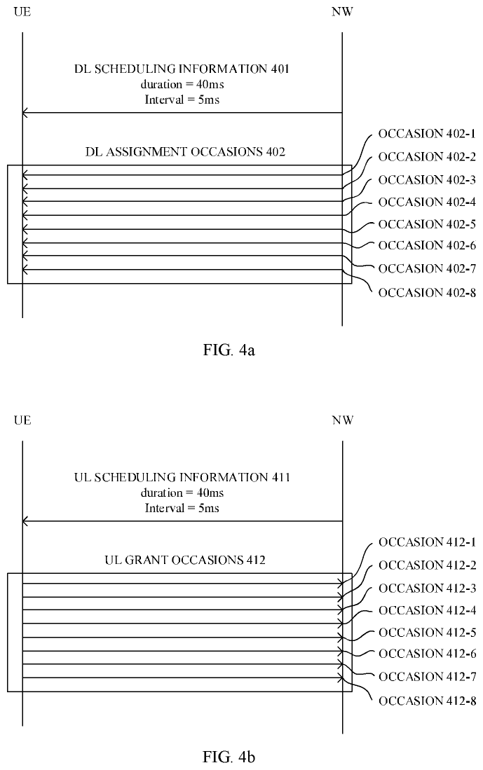

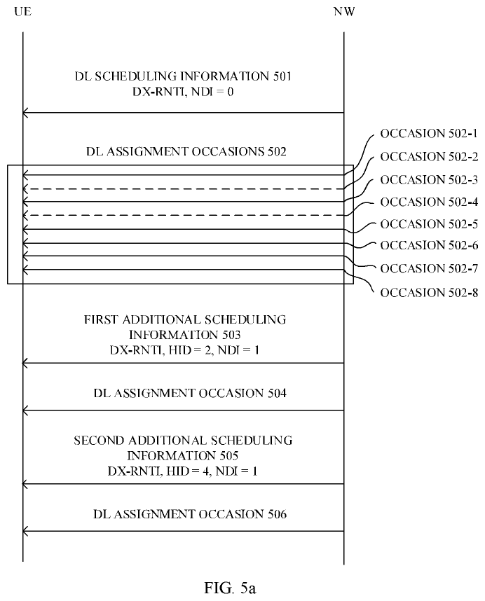

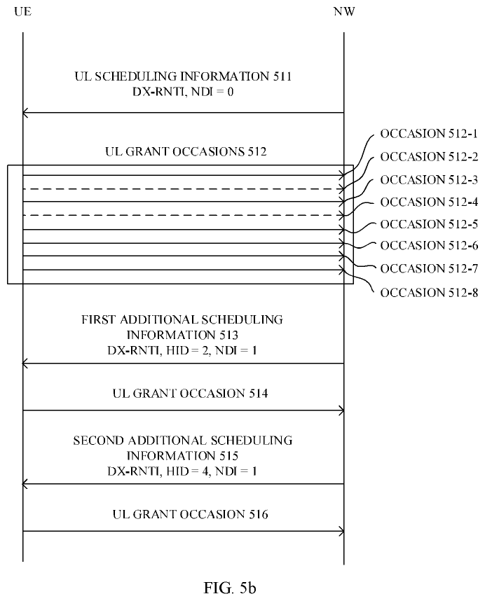

FIGS. 4a-4b illustrate schematic diagrams for an exemplary method for a UE in accordance with some embodiments.

As shown in FIG. 4a, the UE acquires, from the NW, the DL scheduling information 401 for a PDU set with the duration for the data reception (duration=40 ms) and the interval (Interval=5 ms). Therefore, the DL assignment occasions 402 is determined within the 40 ms duration time. The first occasion 402-1 may be determined according to the scheduling information, e.g., determined by the start time of the PDU set. After the first occasion 402-1, each of the following occasions is determined with the given interval 5 ms until achieving the given duration 40 ms. Therefore, in the case shown in FIG. 4a, there are 8 occasions in total (occasion 402-1 to 402-8) in the DL assignment occasions 402 for the DL data reception. In some embodiments, in response to detecting the end of the last occasion 402-8 within the duration, the DL assignment occasions 402 are released.

Similarly, regarding the UL transmission, the scheduling information may include the duration and the interval as well. As shown in FIG. 4b, the UE acquires, from the NW, the UL scheduling information 411 for a PDU set with the duration for the data transmission (duration=40 ms) and the interval (Interval=5 ms). The UL grant occasions 412 is determined within the 40 ms duration, where the first occasion 412-1 may be determined according to the start time of the PDU set. After the first occasion 412-1, each of the following occasions is determined with the given interval 5 ms until achieving the given duration 40 ms. Therefore, in this case shown in FIG. 4b, there are 8 occasions in total (occasion 412-1 to 412-8) in the UL grant occasions 412 for the UL data transmission. In some embodiments, in response to detecting the end of the last occasion 412-8 within the duration, the UL grant occasions 412 are released.

In some embodiments, the DL scheduling information 401 and the UL scheduling information 411 may be acquired by the UE via DCI.

Further, it is to be understood that other values of duration or interval may also be indicated by the DL scheduling information 401 and the UL scheduling information 411, and that the occasions included in the DL assignment occasions 402 and UL grant occasions 412 may be adjusted, respectively.

In some embodiments, the scheduling information indicates a preset type of Radio Network Temporary Identity (RNTI) for the PDU set and a first New Data Indicator (NDI). The performing the data transmission or reception comprises: in accordance with a determination that the preset type of RNTI is included in the acquired scheduling information and that the first NDI has a first value for a PDU in the PDU set, performing the data transmission or reception for the PDU.

In some embodiments, the UE may recognize the scheduling information for a PDU set by the preset type of Radio Network Temporary Identity (RNTI), e.g., DX-RNTI or C-RNTI. In such a case, in response to determining that the acquired scheduling information indicates the preset type of RNTI, the UE can recognize the data transmitted or received via the occasions determined by the scheduling information as the data in a PDU set.

In some embodiments, similar as SPS/CG scheme, the NDI may be used to identify if a received transport block (TB) is a new transmission or retransmission of the data. For example, when NDI is toggled in the scheduling information, UE is informed to transmit or receive new data. When NDI is not toggled in the scheduling information, UE is informed that the data transmitted or received belongs to a same TB. Whether the NDI is toggled can be determined based on the comparison between the current NDI and the previous NDI. For example, if the value of the current NDI is changed comparing to the previous NDI, it is implied that the data transmitted or received belongs to a new TB. Otherwise, the data transmitted or received belongs a same TB. In some embodiments, the NDI toggle may be performed per PDU, per PDU set, or at both the PDU level and the PDU set level simultaneously.

In each of the occasions determined by the scheduling information, similar as the SPS operation, different Hybrid Automatic Repeat Request (HARQ) processes may be performed for the data transmitted or received in each occasion. Multiple HARQ processes are used for the scheduling of a PDU set.

In some embodiments, method 200 may further comprise: performing a Hybrid Automatic Repeat Request (HARQ) process to determine a PDU in the PDU set for which the data transmission or reception was unsuccessful; acquiring additional scheduling information including a HARQ identifier and a second NDI, wherein the HARQ identifier identifies the PDU for which the data transmission or reception was unsuccessful; and in accordance with a determination that the second NDI has a second value different from the first value for the PDU, performing additional data transmission or reception for the identified PDU.

FIGS. 5a-5b illustrate schematic diagrams for an exemplary method for a UE in accordance with some embodiments.

As shown in FIG. 5a, the UE acquires, from the NW, the DL scheduling information 501 for a PDU set with DX-RNTI, which indicates that the scheduling information 501 is used for a PDU set. The DL assignment occasions 502, which includes 8 occasions (occasion 502-1 to 502-8), may be determined based on the DL scheduling information 501 according to any of the above-mentioned methods for a UE.

In some embodiments, the data reception of some occasions maybe unsuccessful during this process. For example, as shown in FIG. 5a, the data reception via occasion 502-2 and occasion 502-4 (which is shown as a dash line) is unsuccessful. Therefore, two HARQ processes are used for the PDUs that were supposed to have been received via occasion 502-2 and occasion 502-4. In one example, the UE acquires, from the NW, the first additional scheduling information 503, which includes a HARQ identifier (HID=2) and an NDI (NDI=1). The HARQ identifier (HID=2) identifies the PDU that was supposed to have been received in occasion 502-2. The NDI (NDI=1) is different from the NDI (NDI=0) in the DL scheduling information 501, and indicates that the scheduled reception is another TB reception of the unsuccessful PDU. Further, after performing the data reception of the corresponding PDU via the DL assignment occasion 504 scheduled by the first additional scheduling information, second scheduling information 505 is acquired by the UE for scheduling the data reception of the PDU that was supposed to have been received in occasion 502-4. Similarly, the second scheduling information 505 indicates a HARQ identifier (HID=4) and an NDI (NDI=1). Then, the UE performs the data reception via the DL assignment occasion 506 scheduled by the second additional scheduling information 505.

Further, similar HARQ utilization is performed in the UL scheduling. As shown in FIG. 5b, the UE acquires, from the NW, the UL scheduling information 511 for a PDU set with DX-RNTI and NDI=0. UL assignment occasions 512, which including 8 occasions (occasion 512-1 to 512-8) may be determined based on the scheduling information through any of the above-mentioned method for a UE.

Similarly, the data transmission of some occasions maybe unsuccessful during this process. For example, as shown in FIG. 5b, the data transmission via occasion 512-2 and 512-4 is unsuccessful. Therefore, two HARQ processes are used for the PDUs that were supposed to have been transmitted via the occasion 512-2 and the occasion 512-4. In one example, first additional scheduling information 513, which indicates a HARQ identifier (HID=2) and an NDI (NDI=1), is acquired by the UE for scheduling the UL grant occasion 514 for transmitting the PDU that was supposed to have been transmitted via occasion 512-2. Second additional scheduling information 514, which indicates a HARQ identifier (HID=4) and an NDI (NDI=1), is acquired by the UE for scheduling the UL grant occasion 516 for transmitting the PDU that was supposed to have been transmitted in occasion 512-4.

In some embodiments, the NW may configure multiple preset types of RNTI for multiple scheduling of PDU set. For example, if UE receives the preset type of RNTI with the NDI for new data transmission or reception, the HARQ process associated with the previous scheduling of PDU set is released. In some embodiments, method 200 may further comprise: in accordance with a determination that the second NDI has the first value, forgoing the HARQ process for the PDU set.

As mentioned above, the UE may acquire the scheduling information from the network side, e.g., from a network device. In such a case, the UE may further provide additional information to the NW to support the PDU set based scheduling.

In some embodiments, the scheduling information is acquired from a network device, and the method for a UE further comprises: transmitting, to the network device, size information of the PDU set. The scheduling information for determining the plurality of occasions for the PDU set is determined based on the size information of the PDU set.

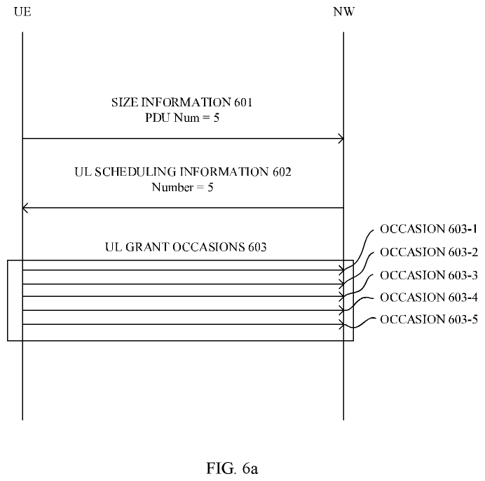

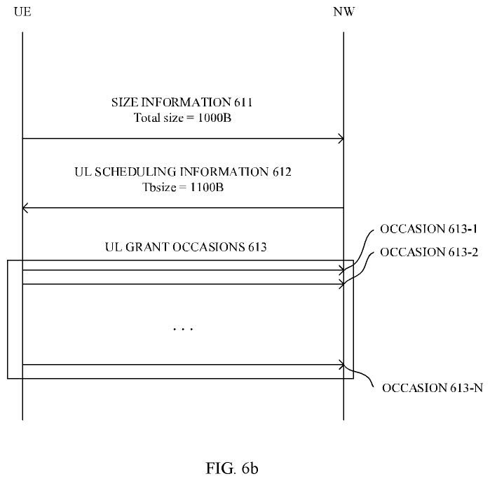

FIG. 6a-6b illustrate schematic diagrams for an exemplary method for a UE in accordance with some embodiments.

In some embodiments, the size information of the PDU set comprises a number of PDUs in the PDU set.

As shown in FIG. 6a, UE provides a size information 601 to the NW, which indicates the number of PDU in a PDU set (PDU Num=5). The number of PDU may be the maximum number of PDU that is allowed in a PDU set, the number of PDU in the given PDU set that is to be transmitted, or other preset number of PDU in a PDU set. Based on the size information 601 provided by the UE, the network device may determine the UL scheduling information. For example, as shown in FIG. 6a, a number of 5 occasions is scheduled in the UL scheduling information 602. After acquiring the UL scheduling information 602, UE performs the data transmission for each of the 5 PDU in the PDU set via the corresponding occasion determined by the UL scheduling information 601, i.e., via occasions 603-1 to 603-5 in the UL grant occasions 603, respectively.

In some embodiments, the size information of the PDU set comprises at least one of: a data amount of the PDU set, a preset data amount for data transmission or reception scheduled by the scheduling information, or a preset data amount for a logical channel (LCH).

As shown in FIG. 6b, the UE provides size information 611 to the NW, which indicates the total data amount of the PDU set (e.g., Total size=1000 B). Alternatively, other size information such as a preset data amount for a PDU set, a preset data amount for one scheduling, or a preset data amount for a particular LCH can be included in the size information 611. Based on the size information 611 provided by the UE, the network device may determine the UL scheduling information 612. For example, as shown in FIG. 6b, a transport block size (TBsize=1100 B) is included in the UL scheduling information 612. UE performs the data transmission in the UL grant occasions 613 determined by the UL scheduling information 612 until achieving the transport block size. Multiple occasions (e.g., occasions 613-1 to 613-N) may be included in the UL grant occasions 613.

In some embodiments, the size information is transmitted via L1, L2, or L3 signaling. The L1 signaling includes uplink control information (UCI) or a scheduling request (SR). The L2 signaling includes a MAC CE. The L3 signaling includes a radio resource control (RRC) message.

In some embodiments, a method for a network device in communication with a user equipment (UE) comprises: transmitting, to the UE, scheduling information in a scheduling occasion for at least one Protocol Data Unit (PDU) in a Protocol Data Unit (PDU) set, wherein the scheduling information is used for determining a plurality of occasions, each of the plurality of occasions corresponds to data transmission or reception of one or more PDU in the PDU set. A bundle of UL grants or DL assignments may be allocated in the scheduling information to determine the occasions for the data transmission or reception of the UE.

For purposes of discussion, the method is described below with reference to FIG. 1. For example, the network device and the UE may be the base station 150 and the UE 101 in FIG. 1, respectively.

In some embodiments, the method for a network device further comprises: generating the scheduling information for determining the plurality of occasions for the PDU set based on Quality of Service (QoS) requirements of the PDU set. The QoS requirements may include a start time of the PDU set and an end time of the PDU set, and the plurality of occasions are between the start time of the PDU set and the end time of the PDU set.

In some embodiments, the scheduling information is transmitted via one of downlink control information (DCI), L2 signaling, or a radio resource control (RRC) message, and the scheduling information indicates a number of the plurality of occasions and an interval between the plurality of occasions. For example, the scheduling information may be the DL scheduling information 301 shown in FIG. 3a, which indicates the number of occasions (Num=8) and the interval (Interval=2 ms) for the DL assignment occasions 302, or the UL scheduling information 311 shown in FIG. 3b, which indicates the number of occasions (Num=8) and the interval (Interval=2 ms) for the UL grant occasions 312.

In some embodiments, the scheduling information is transmitted via downlink control information (DCI), and the scheduling information indicates a duration for data transmission or reception of the PDU set and an interval between the plurality of occasions. For example, the scheduling information may be the DL scheduling information 401 shown in FIG. 4a, which indicates the duration for the data transmission (duration=40 ms) and the interval (Interval=5 ms) for the DL assignment occasions 402, or the UL scheduling information 411 shown in FIG. 3b, which indicates the duration for the data transmission (duration=40 ms) and the interval (Interval=5 ms) for the UL grant occasions 412.

In some embodiments, the scheduling information indicates a preset type of Radio Network Temporary Identity (RNTI) for the PDU set and a first New Data Indicator (NDI) having a first value for a PDU in the PDU set.

For example, the network device may schedule the data transmission or reception for a PDU set by indicating the preset type of RNTI in the scheduling information, e.g., DX-RNTI or C-RNTI. The UE, in response to determining the acquired scheduling information indicates the preset type of RNTI, can recognize the data transmitted or received via the occasions determined by the scheduling information as the data in a PDU set.

Further, similar as SPS/CG scheme, the NDI may be used to identify whether a received TB is a new transmission or retransmission of the data. A toggled NDI is indicated in the scheduling information to identify the transmission or reception of new data.

In some embodiments, the method for the network device further comprises: transmitting, to the UE, additional scheduling information including a HARQ identifier and a second NDI having a second value different from the first value, wherein the HARQ identifier identifies a PDU in the PDU set for which the data transmission or reception was unsuccessful. After acquiring the additional scheduling information from the network device, the UE may perform additional data transmission or reception for the identified PDU which was unsuccessful during the occasions scheduled by the previous scheduling information.

In some embodiments, the method for the network device further comprises: acquiring, from the UE, size information of the PDU set, wherein the scheduling information for determining the plurality of occasions for the PDU set is determined based on the size information of the PDU set.

In some embodiments, the size information may be the size information 601 shown in FIG. 6a, which indicates the number of PDU in a PDU set (PDU Num=5). Based on the size information 601 provided by the UE, the network device may determine the UL scheduling information, and the UE may perform the data transmission for each PDU in the PDU set via the corresponding occasion determined by the UL scheduling information.

In other embodiments, the size information may be the size information 611 shown in FIG. 6b, which includes the total data amount of the PDU set (e.g., Total size=1000 B). Alternatively, other size information such as a preset data amount for a PDU set, a preset data amount for one scheduling, or a preset data amount for a particular LCH can be included in the size information. Based on the size information provided by the UE, the network device may determine the UL scheduling information including a TB size, and the UE may perform the data transmission in the UL grant occasions determined by the UL scheduling information until achieving the transport block size.

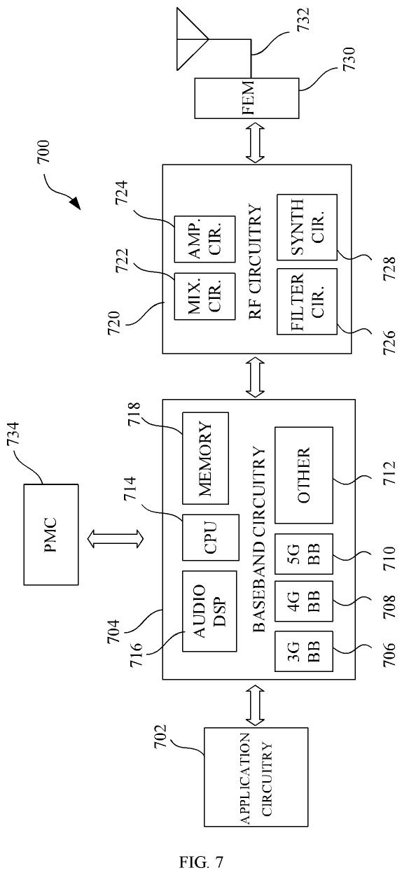

FIG. 7 illustrates example components of a device 700 in accordance with some embodiments. In some embodiments, the device 700 may include application circuitry 702, baseband circuitry 704, Radio Frequency (RF) circuitry (shown as RF circuitry 720), front-end module (FEM) circuitry (shown as FEM circuitry 730), one or more antennas 732, and power management circuitry (PMC) (shown as PMC 734) coupled together at least as shown. The components of the illustrated device 700 may be included in a UE or a RAN node. In some embodiments, the device 700 may include fewer elements (e.g., a RAN node may not utilize application circuitry 702, and instead include a processor/controller to process IP data received from an EPC). In some embodiments, the device 700 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 702 may include one or more application processors. For example, the application circuitry 702 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 700. In some embodiments, processors of application circuitry 702 may process IP data packets received from an EPC.

The baseband circuitry 704 may include circuitry such as, but not limited to, one or more single-core or multi-core processors. The baseband circuitry 704 may include one or more baseband processors or control logic to process baseband signals received from a receive signal path of the RF circuitry 720 and to generate baseband signals for a transmit signal path of the RF circuitry 720. The baseband circuitry 704 may interface with the application circuitry 702 for generation and processing of the baseband signals and for controlling operations of the RF circuitry 720. For example, in some embodiments, the baseband circuitry 704 may include a third generation (3G) baseband processor (3G baseband processor 706), a fourth generation (4G) baseband processor (4G baseband processor 708), a fifth generation (5G) baseband processor (5G baseband processor 710), or other baseband processor(s) 712 for other existing generations, generations in development or to be developed in the future (e.g., second generation (2G), sixth generation (6G), etc.). The baseband circuitry 704 (e.g., one or more of baseband processors) may handle various radio control functions that enable communication with one or more radio networks via the RF circuitry 720. In other embodiments, some or all of the functionality of the illustrated baseband processors may be included in modules stored in the memory 718 and executed via a Central Processing ETnit (CPET 714). The radio control functions may include, but are not limited to, signal modulation/demodulation, encoding/decoding, radio frequency shifting, etc. In some embodiments, modulation/demodulation circuitry of the baseband circuitry 704 may include Fast-Fourier Transform (FFT), precoding, or constellation mapping/demapping functionality. In some embodiments, encoding/decoding circuitry of the baseband circuitry 704 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 704 may include a digital signal processor (DSP), such as one or more audio DSP(s) 716. The one or more audio DSP(s) 716 may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 704 and the application circuitry 702 may be implemented together such as, for example, on a system on a chip (SOC).

In some embodiments, the baseband circuitry 704 may provide for communication compatible with one or more radio technologies. For example, in some embodiments, the baseband circuitry 704 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 704 is configured to support radio communications of more than one wireless protocol may be referred to as multi-mode baseband circuitry.

The RF circuitry 720 may enable communication with wireless networks using modulated electromagnetic radiation through a non-solid medium. In various embodiments, the RF circuitry 720 may include switches, filters, amplifiers, etc. to facilitate the communication with the wireless network. The RF circuitry 720 may include a receive signal path which may include circuitry to down-convert RF signals received from the FEM circuitry 730 and provide baseband signals to the baseband circuitry 704. The RF circuitry 720 may also include a transmit signal path which may include circuitry to up-convert baseband signals provided by the baseband circuitry 704 and provide RF output signals to the FEM circuitry 730 for transmission.

In some embodiments, the receive signal path of the RF circuitry 720 may include mixer circuitry 722, amplifier circuitry 724 and filter circuitry 726. In some embodiments, the transmit signal path of the RF circuitry 720 may include filter circuitry 726 and mixer circuitry 722. The RF circuitry 720 may also include synthesizer circuitry 728 for synthesizing a frequency for use by the mixer circuitry 722 of the receive signal path and the transmit signal path. In some embodiments, the mixer circuitry 722 of the receive signal path may be configured to down-convert RF signals received from the FEM circuitry 730 based on the synthesized frequency provided by synthesizer circuitry 728. The amplifier circuitry 724 may be configured to amplify the down-converted signals and the filter circuitry 726 may be a low-pass filter (LPF) or band-pass filter (BPF) configured to remove unwanted signals from the down-converted signals to generate output baseband signals. Output baseband signals may be provided to the baseband circuitry 704 for further processing. In some embodiments, the output baseband signals may be zero-frequency baseband signals, although this is not a requirement. In some embodiments, the mixer circuitry 722 of the receive signal path may include passive mixers, although the scope of the embodiments is not limited in this respect.

In some embodiments, the mixer circuitry 722 of the transmit signal path may be configured to up-convert input baseband signals based on the synthesized frequency provided by the synthesizer circuitry 728 to generate RF output signals for the FEM circuitry 730. The baseband signals may be provided by the baseband circuitry 704 and may be filtered by the filter circuitry 726.

In some embodiments, the mixer circuitry 722 of the receive signal path and the mixer circuitry 722 of the transmit signal path may include two or more mixers and may be arranged for quadrature downconversion and upconversion, respectively. In some embodiments, the mixer circuitry 722 of the receive signal path and the mixer circuitry 722 of the transmit signal path may include two or more mixers and may be arranged for image rejection (e.g., Hartley image rejection). In some embodiments, the mixer circuitry 722 of the receive signal path and the mixer circuitry 722 may be arranged for direct downconversion and direct upconversion, respectively. In some embodiments, the mixer circuitry 722 of the receive signal path and the mixer circuitry 722 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 720 may include analog-to-digital converter (ADC) and digital-to-analog converter (DAC) circuitry and the baseband circuitry 704 may include a digital baseband interface to communicate with the RF circuitry 720.

In some dual-mode embodiments, a separate radio IC circuitry may be provided for processing signals for each spectrum, although the scope of the embodiments is not limited in this respect.

In some embodiments, the synthesizer circuitry 728 may be a fractional −N synthesizer or a fractional N/N+l synthesizer, although the scope of the embodiments is not limited in this respect as other types of frequency synthesizers may be suitable. For example, synthesizer circuitry 728 may be a delta-sigma synthesizer, a frequency multiplier, or a synthesizer including a phase-locked loop with a frequency divider.

The synthesizer circuitry 728 may be configured to synthesize an output frequency for use by the mixer circuitry 722 of the RF circuitry 720 based on a frequency input and a divider control input. In some embodiments, the synthesizer circuitry 728 may be a fractional N/N+l synthesizer.

In some embodiments, frequency input may be provided by a voltage controlled oscillator (VCO), although that is not a requirement. Divider control input may be provided by either the baseband circuitry 704 or the application circuitry 702 (such as an applications processor) depending on the desired output frequency. In some embodiments, a divider control input (e.g., N) may be determined from a look-up table based on a channel indicated by the application circuitry 702.

Synthesizer circuitry 728 of the RF circuitry 720 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+l (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 728 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 720 may include an IQ/polar converter.

The FEM circuitry 730 may include a receive signal path which may include circuitry configured to operate on RF signals received from one or more antennas 732, amplify the received signals and provide the amplified versions of the received signals to the RF circuitry 720 for further processing. The FEM circuitry 730 may also include a transmit signal path which may include circuitry configured to amplify signals for transmission provided by the RF circuitry 720 for transmission by one or more of the one or more antennas 732. In various embodiments, the amplification through the transmit or receive signal paths may be done solely in the RF circuitry 720, solely in the FEM circuitry 730, or in both the RF circuitry 720 and the FEM circuitry 730.

In some embodiments, the FEM circuitry 730 may include a TX/RX switch to switch between transmit mode and receive mode operation. The FEM circuitry 730 may include a receive signal path and a transmit signal path. The receive signal path of the FEM circuitry 730 may include an LNA to amplify received RF signals and provide the amplified received RF signals as an output (e.g., to the RF circuitry 720). The transmit signal path of the FEM circuitry 730 may include a power amplifier (PA) to amplify input RF signals (e.g., provided by the RF circuitry 720), and one or more filters to generate RF signals for subsequent transmission (e.g., by one or more of the one or more antennas 732).

In some embodiments, the PMC 734 may manage power provided to the baseband circuitry 704. In particular, the PMC 734 may control power-source selection, voltage scaling, battery charging, or DC-to-DC conversion. The PMC 734 may often be included when the device 700 is capable of being powered by a battery, for example, when the device 700 is included in an EGE. The PMC 734 may increase the power conversion efficiency while providing desirable implementation size and heat dissipation characteristics.

FIG. 7 shows the PMC 734 coupled only with the baseband circuitry 704. However, in other embodiments, the PMC 734 may be additionally or alternatively coupled with, and perform similar power management operations for, other components such as, but not limited to, the application circuitry 702, the RF circuitry 720, or the FEM circuitry 730.

In some embodiments, the PMC 734 may control, or otherwise be part of, various power saving mechanisms of the device 700. For example, if the device 700 is in an RRC Connected state, where it is still connected to the RAN node as it expects to receive traffic shortly, then it may enter a state known as Discontinuous Reception Mode (DRX) after a period of inactivity. During this state, the device 700 may power down for brief intervals of time and thus save power.

If there is no data traffic activity for an extended period of time, then the device 700 may transition off to an RRC Idle state, where it disconnects from the network and does not perform operations such as channel quality feedback, handover, etc. The device 700 goes into a very low power state and it performs paging where again it periodically wakes up to listen to the network and then powers down again. The device 700 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 702 and processors of the baseband circuitry 704 may be used to execute elements of one or more instances of a protocol stack. For example, processors of the baseband circuitry 704, alone or in combination, may be used to execute Layer 3, Layer 2, or Layer 1 functionality, while processors of the application circuitry 702 may utilize data (e.g., packet data) received from these layers and further execute Layer 4 functionality (e.g., transmission communication protocol (TCP) and user datagram protocol (UDP) layers). As referred to herein, Layer 3 may include a radio resource control (RRC) layer, described in further detail below. As referred to herein, Layer 2 may include a medium access control (MAC) layer, a radio link control (RLC) layer, and a packet data convergence protocol (PDCP) layer, described in further detail below. As referred to herein, Layer 1 may include a physical (PHY) layer of a UE/RAN node, described in further detail below.

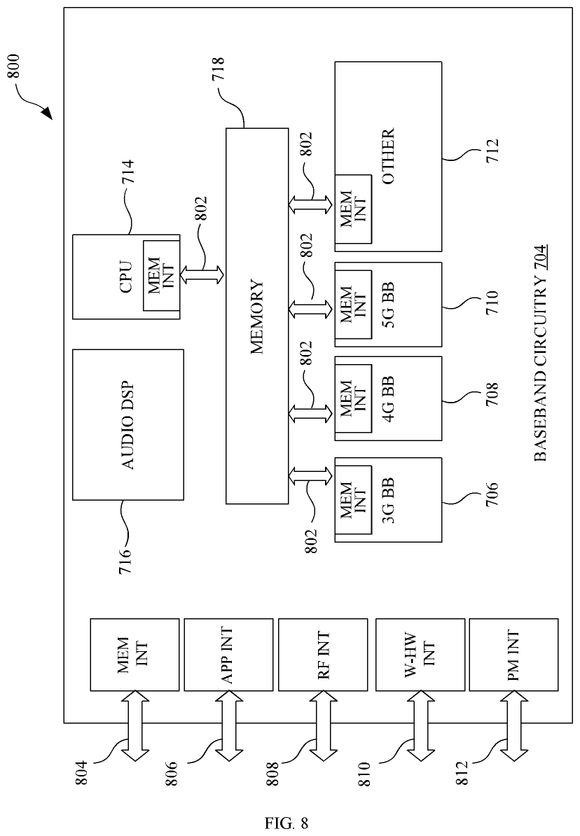

FIG. 8 illustrates example interfaces 800 of baseband circuitry in accordance with some embodiments. As discussed above, the baseband circuitry 704 of FIG. 7 may include 3G baseband processor 706, 4G baseband processor 708, 5G baseband processor 710, other baseband processor(s) 712, CPU 714, and a memory 718 utilized by said processors. As illustrated, each of the processors may include a respective memory interface 802 to send/receive data to/from the memory 718.

The baseband circuitry 704 may further include one or more interfaces to communicatively couple to other circuitries/devices, such as a memory interface 804 (e.g., an interface to send/receive data to/from memory external to the baseband circuitry 704), an application circuitry interface 806 (e.g., an interface to send/receive data to/from the application circuitry 702 of FIG. 7), an RF circuitry interface 808 (e.g., an interface to send/receive data to/from RF circuitry 720 of FIG. 7), a wireless hardware connectivity interface 810 (e.g., an interface to send/receive data to/from Near Field Communication (NFC) components, Bluetooth® components (e.g., Bluetooth® Low Energy), Wi-Fi® components, and other communication components), and a power management interface 812 (e.g., an interface to send/receive power or control signals to/from the PMC 734.

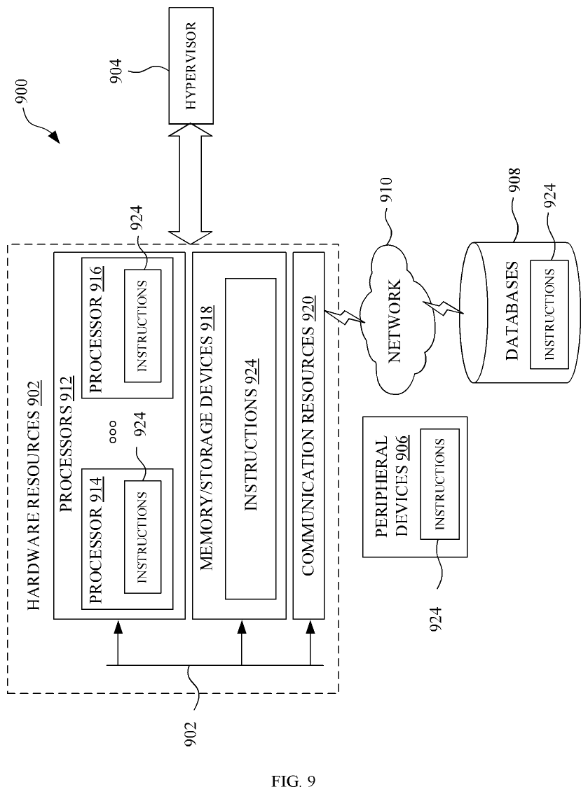

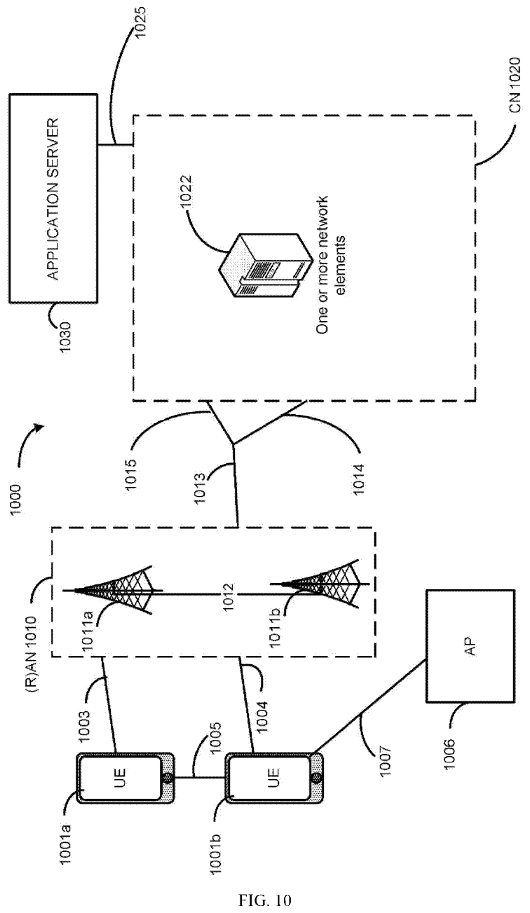

FIG. 9 is a block diagram illustrating components 900, according to some example embodiments, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 902 including one or more processors 912 (or processor cores), one or more memory/storage devices 918, and one or more communication resources 920, each of which may be communicatively coupled via a bus 922. For embodiments where node virtualization (e.g., NFV) is utilized, a hypervisor 904 may be executed to provide an execution environment for one or more network slices/sub-slices to utilize the hardware resources 902.

The processors 912 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 914 and a processor 916.

The memory/storage devices 918 may include main memory, disk storage, or any suitable combination thereof. The memory/storage devices 918 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 920 may include interconnection or network interface components or other suitable devices to communicate with one or more peripheral devices 906 or one or more databases 908 via a network 910. For example, the communication resources 920 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 924 may include software, a program, an application, an applet, an app, or other executable code for causing at least any of the processors 912 to perform any one or more of the methodologies discussed herein. The instructions 924 may reside, completely or partially, within at least one of the processors 912 (e.g., within the processor's cache memory), the memory/storage devices 918, or any suitable combination thereof. Furthermore, any portion of the instructions 924 may be transferred to the hardware resources 902 from any combination of the peripheral devices 906 or the databases 908. Accordingly, the memory of the processors 912, the memory/storage devices 918, the peripheral devices 906, and the databases 908 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

FIG. 10 illustrates an architecture of a system 1000 of a network in accordance with some embodiments. The following description is provided for an example system 1000 that operates in conjunction with the LTE system standards and 5G or NR system standards as provided by 3GPP technical specifications. However, the example embodiments are not limited in this regard and the described embodiments may apply to other networks that benefit from the principles described herein, such as future 3GPP systems (e.g., Sixth Generation (6G)) systems), or the like.

As shown by FIG. 10, the system 1000 includes UE 1001a and UE 1001b (collectively referred to as “UEs 1001” or “UE 1001”). The UE 1001a and/or UE 1001b may correspond to the UEs described above.

In this example, UEs 1001 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

In some embodiments, any of the UEs 1001 may be IoT UEs, which may comprise a network access layer designed for low-power IoT applications utilizing short-lived UE connections. An IoT UE can utilize technologies such as M2M or MTC for exchanging data with an MTC server or device via a PLMN, ProSe or D2D communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 1001 may be configured to connect, for example, communicatively couple, with an or RAN 1010. In embodiments, the RAN 1010 may be an NG RAN or a 5G RAN, an E-UTRAN, or a legacy RAN, such as a UTRAN or GERAN. As used herein, the term “NG RAN” or the like may refer to a RAN 1010 that operates in an NR or 5G system 1000, and the term “E-UTRAN” or the like may refer to a RAN 1010 that operates in an LTE or 4G system 1000. The UEs 1001 utilize connections (or channels) 1003 and 1004, respectively, each of which comprises a physical communications interface or layer (discussed in further detail below).

In this example, the connections 1003 and 1004 are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, a 5G protocol, a NR protocol, and/or any of the other communications protocols discussed herein. In embodiments, the UEs 1001 may directly exchange communication data via a ProSe interface 1005. The ProSe interface 1005 may alternatively be referred to as a SL interface 1005 and may comprise one or more logical channels, including but not limited to a PSCCH, a PSSCH, a PSDCH, and a PSBCH.

The UE 1001b is shown to be configured to access an AP 1006 (also referred to as “WLAN node 1006”, “WLAN 1006”, “WLAN Termination 1006”, “WT 1006” or the like) via connection 1007. The connection 1007 can comprise a local wireless connection, such as a connection consistent with any IEEE 802.11 protocol, wherein the AP 1006 would comprise a wireless fidelity (Wi-Fi®) router. In this example, the AP 1006 is shown to be connected to the Internet without connecting to the core network of the wireless system (described in further detail below). In various embodiments, the UE 1001b, RAN 1010, and AP 1006 may be configured to utilize LWA operation and/or LWIP operation. The LWA operation may involve the UE 1001b in RRC CONNECTED being configured by a RAN node 1011a-b to utilize radio resources of LTE and WLAN. LWIP operation may involve the UE 1001b using WLAN radio resources (e.g., connection 1007) via IPsec protocol tunneling to authenticate and encrypt packets (e.g., IP packets) sent over the connection 1007. IPsec tunneling may include encapsulating the entirety of original IP packets and adding a new packet header, thereby protecting the original header of the IP packets.

The RAN 1010 can include one or more AN nodes or RAN nodes 1011a and 1011b (collectively referred to as “RAN nodes 1011” or “RAN node 1011”) that enable the connections 1003 and 1004. As used herein, the terms “access node”, “access point” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node 1011 that operates in an NR or 5G system 1000 (for example, a gNB), and the term “E-UTRAN node” or the like may refer to a RAN node 1011 that operates in an LTE or 4G system 1000 (e.g., an eNB). According to various embodiments, the RAN nodes 1011 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the RAN nodes 1011 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes 1011; a MAC/PHY split wherein RRC, PDCP, RLC, and MAC layers are operated by the CRAN/vBBUP and the PHY layer is operated by individual RAN nodes 1011; or a “lower PHY” split wherein RRC, PDCP, RLC, MAC layers and upper portions of the PHY layer are operated by the CRAN/vBBUP and lower portions of the PHY layer are operated by individual RAN nodes 1011. This virtualized framework allows the freed-up processor cores of the RAN nodes 1011 to perform other virtualized applications. In some implementations, an individual RAN node 1011 may represent individual gNB-DUs that are connected to a gNB-CU via individual FI interfaces (not shown by FIG. 10). In these implementations, the gNB-DUs may include one or more remote radio heads or RFEMs, and the gNB-CU may be operated by a server that is located in the RAN 1010 (not shown) or by a server pool in a similar manner as the CRAN/vBBUP. Additionally or alternatively, one or more of the RAN nodes 1011 may be next generation eNBs (ng-eNBs), which are RAN nodes that provide E-UTRA user plane and control plane protocol terminations toward the UEs 1001, and are connected to a 5G core (5GC) via an NG interface.

In V2X scenarios one or more of the RAN nodes 1011 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs 1001 (vUEs 1001). The RSU may also include internal data storage circuitry to store intersection map geometry, traffic statistics, media, as well as applications/software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) and/or provide connectivity to one or more cellular networks to provide uplink and downlink communications. The computing device(s) and some or all of the radiofrequency circuitry of the RSU may be packaged in a weatherproof enclosure suitable for outdoor installation, and may include a network interface controller to provide a wired connection (e.g., Ethernet) to a traffic signal controller and/or a backhaul network.

Any of the RAN nodes 1011 can terminate the air interface protocol and can be the first point of contact for the UEs 1001. In some embodiments, any of the RAN nodes 1011 can fulfill various logical functions for the RAN 1010 including, but not limited to, radio network controller (RNC) functions such as radio bearer management, uplink and downlink dynamic radio resource management and data packet scheduling, and mobility management.

In embodiments, the UEs 1001 can be configured to communicate using OFDM communication signals with each other or with any of the RAN nodes 1011 over a multi carrier communication channel in accordance with various communication techniques, such as, but not limited to, an OFDMA communication technique (e.g., for downlink communications) or a SC-FDMA communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1011 to the UEs 1001, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

According to various embodiments, the UEs 1001 and the RAN nodes 1011 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band.

To operate in the unlicensed spectrum, the UEs 1001 and the RAN nodes 1011 may operate using LAA, eLAA, and/or feLAA mechanisms. In these implementations, the UEs 1001 and the RAN nodes 1011 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (for example, UEs 1001, RAN nodes 1011 etc.) senses a medium (for example, a channel or carrier frequency) and transmits when the medium is sensed to be idle (or when a specific channel in the medium is sensed to be unoccupied). The medium sensing operation may include CCA, which utilizes at least ED to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF energy across an intended transmission band for a period of time and comparing the sensed RF energy to a predefined or configured threshold.

Typically, the incumbent systems in the 5 GHz band are WLANs based on IEEE 802.11 technologies. WLAN employs a contention-based channel access mechanism, called CSMA/CA. Here, when a WLAN node (e.g., a mobile station (MS) such as UE 1001, AP 1006, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS, which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL transmission bursts including PDSCH or PUSCH transmissions, respectively, may have an LAA contention window that is variable in length between X and Y ECCA slots, where X and Y are minimum and maximum values for the CWSs for LAA. In one example, the minimum CWS for an LAA transmission may be 9 microseconds (ps); however, the size of the CWS and a MCOT (for example, a transmission burst) may be based on governmental regulatory requirements.

The LAA mechanisms are built upon CA technologies of LTE-Advanced systems. In CA, each aggregated carrier is referred to as a CC. A CC may have a bandwidth of 1.4, 3, 5, 10, 15 or 20 MHz and a maximum of five CCs can be aggregated, and therefore, a maximum aggregated bandwidth is 100 MHz. In FDD systems, the number of aggregated carriers can be different for DL and UL, where the number of UL CCs is equal to or lower than the number of DL component carriers. In some cases, individual CCs can have a different bandwidth than other CCs. In TDD systems, the number of CCs as well as the bandwidths of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require the UE 1001 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH carries user data and higher-layer signaling to the UEs 1001. The PDCCH carries information about the transport format and resource allocations related to the PDSCH channel, among other things. It may also inform the UEs 1001 about the transport format, resource allocation, and HARQ information related to the uplink shared channel. Typically, downlink scheduling (assigning control and shared channel resource blocks to the UE 1001b within a cell) may be performed at any of the RAN nodes 1011 based on channel quality information fed back from any of the UEs 1001. The downlink resource assignment information may be sent on the PDCCH used for (e.g., assigned to) each of the UEs 1001.

The PDCCH uses control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to six resource element groups (REGs). Each REG comprises one resource block in one OFDM symbol. The PDCCH can be transmitted using one or more CCEs, depending on the size of the downlink control information (DCI) and the channel condition. Different numbers of CCEs (e.g., aggregation level, L=l, 2, 4, 8 or 16) can be used for transmission of the PDCCH.

Some embodiments may use concepts for resource allocation for control channel information that are an extension of the above-described concepts. For example, some embodiments may utilize an EPDCCH that uses PDSCH resources for control information transmission. The EPDCCH may be transmitted using one or more ECCEs. Similar to above, each ECCE may correspond to nine sets of four physical resource elements known as an EREGs. An ECCE may have other numbers of EREGs in some situations.

The RAN nodes 1011 may be configured to communicate with one another via interface 1012. In embodiments where the system 1000 is an LTE system (e.g., when CN 1020 is an EPC), the interface 1012 may be an X2 interface 1012. The X2 interface may be defined between two or more RAN nodes 1011 (e.g., two or more eNBs and the like) that connect to EPC 1020, and/or between two eNBs connecting to EPC 1020. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB to an SeNB; information about successful in sequence delivery of PDCP PDUs to a UE 1001 from an SeNB for user data; information of PDCP PDUs that were not delivered to a UE 1001; information about a current minimum desired buffer size at the SeNB for transmitting to the UE user data; and the like. The X2-C may provide intra-LTE access mobility functionality, including context transfers from source to target eNBs, user plane transport control, etc.; load management functionality; as well as inter-cell interference coordination functionality. In embodiments where the system 1000 is a 5G or NR system (e.g., when CN 1020 is an 5GC), the interface 1012 may be an Xn interface 1012. The Xn interface is defined between two or more RAN nodes 1011 (e.g., two or more gNBs and the like) that connect to 5GC 1020, between a RAN node 1011 (e.g., a gNB) connecting to 5GC 1020 and an eNB, and/or between two eNBs connecting to 5GC 1020. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 1001 in a connected mode (e.g., CM-CONNECTED) including functionality to manage the UE mobility for connected mode between one or more RAN nodes 1011. The mobility support may include context transfer from an old (source) serving RAN node 1011 to new (target) serving RAN node 1011; and control of user plane tunnels between old (source) serving RAN node 1011 to new (target) serving RAN node 1011. A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

The RAN 1010 is shown to be communicatively coupled to a core network—in this embodiment, core network (CN) 1020. The CN 1020 may comprise a plurality of network elements 1022, which are configured to offer various data and telecommunications services to customers/subscribers (e.g., users of UEs 1001) who are connected to the CN 1020 via the RAN 1010. The components of the CN 1020 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of the CN 1020 may be referred to as a network slice, and a logical instantiation of a portion of the CN 1020 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, the application server 1030 may be an element offering applications that use IP bearer resources with the core network (e.g., UMTS PS domain, LTE PS data services, etc.). The application server 1030 can also be configured to support one or more communication services (e.g., VoIP sessions, PTT sessions, group communication sessions, social networking services, etc.) for the UEs 1001 via the EPC 1020.

In embodiments, the CN 1020 may be a 5GC (referred to as “5GC 1020” or the like), and the RAN 1010 may be connected with the CN 1020 via an NG interface 1013. In embodiments, the NG interface 1013 may be split into two parts, an NG user plane (NG-U) interface 1014, which carries traffic data between the RAN nodes 1011 and a UPF, and the SI control plane (NG-C) interface 1015, which is a signaling interface between the RAN nodes 1011 and AMFs.

In embodiments, the CN 1020 may be a 5G CN (referred to as “5GC 1020” or the like), while in other embodiments, the CN 1020 may be an EPC). Where CN 1020 is an EPC (referred to as “EPC 1020” or the like), the RAN 1010 may be connected with the CN 1020 via an SI interface 1013. In embodiments, the SI interface 1013 may be split into two parts, an SI user plane (SI-U) interface 1014, which carries traffic data between the RAN nodes 1011 and the S-GW, and the Sl-MME interface 1015, which is a signaling interface between the RAN nodes 1011 and MMEs.

### ADDITIONAL EXAMPLES

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.

Example 1 is a method for a user equipment (UE), comprising: acquiring scheduling information in a scheduling occasion for at least one Protocol Data Unit (PDU) in a PDU set, wherein the scheduling information is used for determining a plurality of occasions, each of the plurality of occasions corresponds to data transmission or reception of one or more PDU in the PDU set; and performing data transmission or reception for each PDU in the PDU set via a corresponding occasion of the plurality of occasions determined by the scheduling information.

Example 2 is the method of example 1, wherein the plurality of occasions are determined by the scheduling information based on Quality of Service (QoS) requirements of the PDU set.

Example 3 is the method of example 2, wherein the QoS requirements include a start time of the PDU set and an end time of the PDU set, and the plurality of occasions are between the start time of the PDU set and the end time of the PDU set.

Example 4 is the method of any one of examples 1-3, wherein the scheduling information is acquired via one of downlink control information (DCI), L2 signaling, or a radio resource control (RRC) message, and the scheduling information indicates a number of the plurality of occasions and an interval between the plurality of occasions, and wherein the performing the data transmission or reception comprises: performing the data transmission or reception via the number of the plurality of occasions with the interval, wherein each PDU is transmitted or received via a corresponding occasion of the plurality of occasions.

Example 5 is the method of example 1, wherein the scheduling information is acquired via downlink control information (DCI), and the scheduling information indicates a duration for the data transmission or reception of the PDU set and an interval between the plurality of occasions, and wherein the performing the data transmission or reception comprises: performing the data transmission or reception via the plurality of occasions in the duration with the interval, wherein each PDU is transmitted or received via a corresponding occasion of the plurality of occasions.

Example 6 is the method of any one of examples 1-5, wherein the scheduling information indicates a preset type of Radio Network Temporary Identity (RNTI) for the PDU set and a first New Data Indicator (NDI), and wherein the performing the data transmission or reception comprises: in accordance with a determination that the preset type of RNTI is included in the acquired scheduling information and that the first NDI has a first value for a PDU in the PDU set, performing the data transmission or reception for the PDU.

Example 7 is the method of example 6, further comprising: performing a Hybrid Automatic Repeat Request (HARQ) process to determine a PDU in the PDU set for which the data transmission or reception was unsuccessful; acquiring additional scheduling information including a HARQ identifier and a second NDI, wherein the HARQ identifier identifies the PDU for which the data transmission or reception was unsuccessful; and in accordance with a determination that the second NDI has a second value different from the first value for the PDU, performing additional data transmission or reception for the identified PDU.

Example 8 is the method of example 7, further comprising: in accordance with a determination that the second NDI has the first value, forgoing the HARQ process for the PDU set.

Example 9 is the method of any one of examples 1-8, wherein the scheduling information is acquired from a network device, the method further comprising: transmitting, to the network device, size information of the PDU set, wherein the scheduling information for determining the plurality of occasions for the PDU set is determined based on the size information of the PDU set.

Example 10 is the method of example 9, wherein the size information of the PDU set comprises a number of PDUs in the PDU set.

Example 11 is the method of example 9, wherein the size information of the PDU set comprises at least one of: a data amount of the PDU set, a preset data amount for data transmission or reception scheduled by the scheduling information, or a preset data amount for a logical channel (LCH).

Example 12 is the method of example 9 or 10, wherein the size information is transmitted via L1, L2, or L3 signaling, wherein the L1 signaling includes uplink control information (UCI) or a scheduling request (SR), the L2 signaling includes a MAC CE, and the L3 signaling includes a radio resource control (RRC) message.

Example 13 is a method for a network device in communication with a user equipment (UE), comprising: transmitting, to the UE, scheduling information in a scheduling occasion for at least one Protocol Data Unit (PDU) in a Protocol Data Unit (PDU) set, wherein the scheduling information is used for determining a plurality of occasions, each of the plurality of occasions corresponds to data transmission or reception of one or more PDU in the PDU set.

Example 14 is the method of example 13, further comprising: generating the scheduling information for determining the plurality of occasions for the PDU set based on Quality of Service (QoS) requirements of the PDU set.

Example 15 is the method of example 13, wherein the scheduling information is acquired via one of downlink control information (DCI), L2 signaling, or a radio resource control (RRC) message, and the scheduling information indicates a number of the plurality of occasions and an interval between the plurality of occasions.

Example 16 is the method of example 13, wherein the scheduling information is acquired via downlink control information (DCI), and the scheduling information indicates a duration for data transmission or reception of the PDU set and an interval between the plurality of occasions.

Example 17 is the method of any one of examples 13-16, wherein the scheduling information indicates a preset type of Radio Network Temporary Identity (RNTI) for the PDU set and a first New Data Indicator (NDI) having a first value for a PDU in the PDU set.

Example 18 is the method of example 17, further comprising: transmitting, to the UE, additional scheduling information including a HARQ identifier and a second NDI having a second value different from the first value, wherein the HARQ identifier identifies a PDU in the PDU set for which the data transmission or reception was unsuccessful.

Example 19 is the method of any one of examples 13-18, further comprising: acquiring, from the UE, size information of the PDU set, wherein the scheduling information for determining the plurality of occasions for the PDU set is determined based on the size information of the PDU set.

Example 20 is an apparatus for a communication device, comprising means for performing steps of the method according to any of examples 1-19.

Example 21 is an apparatus for a user equipment (UE), the apparatus comprising one or more processors configured to perform the method of any of examples 1 to 12.

Example 22 is an apparatus for a network device, the apparatus comprising one or more processors configured to perform the method of any of examples 13 to 19.

Example 23 is a computer readable medium having computer programs stored thereon which, when executed by an apparatus having one or more processors, cause the apparatus to perform the method of any of examples 1 to 19.

Example 24 is a computer program product comprising computer programs which, when executed by an apparatus having one or more processors, cause the apparatus to perform the method of any of examples 1 to 19.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-20. (canceled)

21. A method comprising:
acquiring scheduling information in a scheduling occasion for at least one Protocol Data Unit (PDU) in a PDU set;
determining, based on the scheduling information, a plurality of occasions, wherein each of the plurality of occasions corresponds to data transmission or reception of one or more PDU in the PDU set; and
performing data transmission or reception for each PDU in the PDU set via a corresponding occasion of the plurality of occasions.

22. The method of claim 21, wherein determining the plurality of occasions further comprises:
determining the plurality of occasions based on Quality of Service (QoS) requirements of the PDU set.

23. The method of claim 22, wherein the QoS requirements include a start time of the PDU set and an end time of the PDU set, and the plurality of occasions are between the start time of the PDU set and the end time of the PDU set.

24. The method of claim 21, wherein the scheduling information is acquired via one of downlink control information (DCI), layer 2 (L2) signaling, or a radio resource control (RRC) message, and the scheduling information indicates a number of the plurality of occasions and an interval between the plurality of occasions, wherein performing the data transmission or reception comprises:
performing the data transmission or reception via the number of the plurality of occasions with the interval, wherein each PDU is transmitted or received via a corresponding occasion of the plurality of occasions.

25. The method of claim 21, wherein the scheduling information is acquired via downlink control information (DCI), and the scheduling information indicates a duration for the data transmission or reception of the PDU set and an interval between the plurality of occasions, wherein the performing the data transmission or reception comprises:
performing the data transmission or reception via the plurality of occasions in the duration with the interval, wherein each PDU is transmitted or received via a corresponding occasion of the plurality of occasions.

26. The method of claim 21, wherein the scheduling information indicates a preset type of Radio Network Temporary Identity (RNTI) for the PDU set and a first New Data Indicator (NDI), wherein the performing the data transmission or reception comprises:
performing the data transmission or reception for the PDU based on a determination that the preset type of RNTI is indicated in the acquired scheduling information and that the first NDI has a first value for a PDU in the PDU set.

27. The method of claim 26, further comprising:
performing a Hybrid Automatic Repeat Request (HARQ) process to determine a PDU in the PDU set for which the data transmission or reception was unsuccessful;
acquiring additional scheduling information including a HARQ identifier and a second NDI, wherein the HARQ identifier identifies the PDU for which the data transmission or reception was unsuccessful; and
performing additional data transmission or reception for the identified PDU based on a determination that the second NDI has a second value different from the first value for the PDU.

28. The method of claim 27, further comprising:
forgoing the HARQ process for the PDU set based on a determination that the second NDI has the first value.

29. The method of claim 21, wherein the scheduling information is acquired from a network device and the method further comprises:
transmitting, to the network device, size information of the PDU set,
wherein the scheduling information for determining the plurality of occasions for the PDU set is determined based on the size information of the PDU set.

30. The method of claim 29, wherein the size information of the PDU set comprises a number of PDUs in the PDU set.

31. The method of claim 29, wherein the size information of the PDU set comprises at least one of: a data amount of the PDU set, a preset data amount for data transmission or reception scheduled by the scheduling information, or a preset data amount for a logical channel (LCH).

32. The method of claim 29, wherein the size information is transmitted via: L1 signaling that includes uplink control information (UCI) or a scheduling request (SR), L2 signaling that includes a MAC CE, or L3 signaling that includes a radio resource control (RRC) message.

33. A method comprising:
generating scheduling information to identify a plurality of occasions, each of the plurality of occasions corresponds to data transmission or reception of one or more Protocol Data Units (PDUs) in a PDU set; and
outputting the scheduling information for transmission to a user equipment (UE) in a scheduling occasion for at least one PDU in the PDU set.

34. The method of claim 33, wherein generating the scheduling information further comprises:
generating the scheduling information based on Quality of Service (QoS) requirements of the PDU set.

35. The method of claim 33, wherein outputting the scheduling information further comprises:
outputting the scheduling information for transmission via one of downlink control information (DCI), L2 signaling, or a radio resource control (RRC) message.

36. The method of claim 33, wherein the scheduling information indicates a number of the plurality of occasions and an interval between the plurality of occasions.

37. The method of claim 33, wherein outputting the scheduling information further comprises:
outputting the scheduling information for transmission via downlink control information (DCI), and the scheduling information indicates a duration for data transmission or reception of the PDU set and an interval between the plurality of occasions.

38. The method of claim 33, wherein the scheduling information indicates a preset type of Radio Network Temporary Identity (RNTI) for the PDU set and a first New Data Indicator (NDI) having a first value for a PDU in the PDU set.

39. The method of claim 38, further comprising:
generating additional scheduling information for transmission to the UE, wherein the additional scheduling information includes a HARQ identifier and a second NDI having a second value different from the first value, wherein the HARQ identifier identifies a PDU in the PDU set for which the data transmission or reception was unsuccessful.

40. The method of claim 33, further comprising:
acquiring, from the UE, size information of the PDU set; and
generating the scheduling information based on the size information.
